(19) United States
(12) Patent Application Publication
(10) Pub. No.: US 2002/0109918 A1
(43) Pub. Date: Aug. 15, 2002

(54) Polarization beam splitter/combiner

(75) Inventors: Li Wu, Fuxing Investment District (CN); Jiwu Ling, Fuxing Investment District (CN); Cuilian Zhan, Fuxing Investment District (CN); Shoufeng Lin, Fuxing Investment District (CN)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA (US)

(21) Appl. No.: 10/003,017

(22) Filed: Nov. 2, 2001

(30) Foreign Application Priority Data
Nov. 3, 2000 (CN) 240875.9

(51) Int. Cl. G02B 5/30; G02B 27/28

(52) U.S. Cl. 359/496; 359/495; 359/494

(57) ABSTRACT

A beam splitter and/or beam combiner is disclosed which in a splitting mode of operation receives an input beam of light and splits the beam into two orthogonally polarized parallel sub-beams of light. The device uses two wedges wherein at least one is birefringent or wherein both are birefringent such as a Wallaston prism, for splitting the input beam into two sub-beams wherein at least one diverges from the other, to provide two diverging beams. Only one or two small crystals are required to do this beam splitting. The two diverging beams are then made parallel by passing them through a prism, such as a roof prism, spaced from the beam splitting prism(s).

The present invention relates to optical fiber network device technology and, more particularly, to devices which can split or combine light signals in dependence upon their state of polarization.

In modern fiberoptic telecommunications, there is a requirement for components that can provide a variety of different functions such as switching, wavelength multiplexing, combining and splitting etc. Many of these components use the state of polarization of light signal in their operation. For example, network components or devices which function based upon the polarization of light signals include polarization tunable filters, depolarizers, binary polarization switch/modulators, polarization division multiplexers and many other polarization related components. Many, if not all, of these devices require polarization beam splitters (PBSs) which can be coupled to optical fibres. For example, devices using PBSs are described in U.S. application Ser. No. 08/406,212 entitled, “VARIABLE POLARIZATION BEAM SPLITTER, COMBINER AND MIXER”, filed Feb. 22, 1995 by J. J. Pan and assigned to the present assignee.

A polarization beam splitter, is a three port device which can be used in an opposite direction, as a polarization beam combiner. Hence two linearly orthogonally polarized signals can be launched into two ports to be combined in general to form a single signal of elliptical polarization exiting the single port in a combining mode of operation, or alternatively, a single signal can be launched into the single port and split by the same device into two orthogonally linearly polarized sub-beams exiting the two ports in a splitting mode of operation.

In this specification, it should be understood that when defining the structure and describing the operation of a polarization beam splitter, it is intended that the device serve as a polarization beam combiner when it is desired to operate the device in that manner.

In a conventional polarization beam splitter cube, a pair of right angle prisms, is often used for its polarization beam splitting functions. The face of the hypotenuse of one prism is bonded to the hypotenuse face of the second prism with special dielectric materials to form a polarizing beam splitter cube with an internal interface at an angle 45° to the external faces of the cube. Incoming light which travels perpendicularly to one of the external faces is refracted through the interface or reflected at the interface 90° to the incoming light according to the polarization of the light. Light which is linearly polarized in the plane of incidence is transmitted through the cube. Light which is linearly polarized perpendicularly to the plane of incidence is reflected by the cube. One limitation of this type of polarizer is that in some instances, the extinction ratio provided by a beam splitting cube is not adequate.

Another type of polarization beam splitter is the Glan-Laser PBS in which two right angle prisms of birefringent crystals are used. The face of the hypotenuse of one prism is separated slightly from the hypotenuse face of the second prism. Although the Glan PBS serves its intended function, the beams exiting therefrom are non-parallel. Orthogonally oriented Wallaston prisms also serve as polarization beam splitters, however the output beams are non-parallel. These prisms are tapered plates which can be made from rutile, calcite, or yttrium orthovanadate or other crystalline birefringent material.

It is well known and common practice to use a single birefringent crystal as polarization beam splitter especially in optical isolators, optical circulators, and in optical interleavers. For example, U.S. Pat. No. 5,204,771 in the name of Koga, discloses the use of a birefringent element which receives an input beam of light and separates the beam into two orthogonally polarized parallel output beams; U.S. Pat. No. 5,867,291 discloses a similar use for a birefringent crystal in a different application. Unfortunately in order to obtain large separation between the two separated orthogonally polarized sub-beams, a large birefringent element is required. In fact the amount of separation increases with the size of the crystal. The cost of large crystals is quite high and the availability is also a consideration.

It is therefore an object of this invention to provide an inexpensive polarization beam splitting or combing device, which is splits a beam into two parallel beams in a splitting mode of operation or combines two parallel beams in a polarization dependent manner in a combining mode of operation.

It is an object of this invention to provide a beam splitting device which does not require a large birefringent element to achieve a large separation between parallel output separated sub-beams.

### SUMMARY OF THE INVENTION

In accordance with an aspect of the invention, there is provided, a polarization beam splitter comprising a first beam splitting means comprising at least one birefringent element having a port for receiving an input beam and having two output ports, said first means for separating the input beam into two orthogonally polarized non-parallel output sub-beams; and, converting means optically coupled to the two output ports of the first beam splitting means for receiving the non-parallel output sub-beams and for converting said non-parallel output sub-beams to parallel output beams.

In accordance with the invention there is provided a beam splitting device with a substantially high extinction ratio which utilizes a birefringent element for separating two beams in a polarization dependent manner such that they are divergent and non-parallel, and which uses an inexpensive non-birefringent light transmissive prism, to convert the divergent beams to separated parallel sub-beams.

In accordance with another aspect of the invention there is provided a a polarization beam combiner comprising a second beam combining means comprising at least one birefringent element having a port for outputting a combined beam and having two input ports for receiving two orthogonally polarized parallel sub-beams, said first means for separating the input beam into two orthogonally polarized non-parallel output sub-beams; and, converting means optically coupled to the two output ports of the first beam splitting means for receiving the non-parallel output sub-beams and for converting said non-parallel output sub-beams to parallel output beams.

Advantageously, the device in accordance with this invention utilizes the ability to achieve separation and angular diversity of two split orthogonal polarized sub-beams such that using a very small crystal or crystals diverging orthogonally polarized sub-beams result, propagating in free space, and by subsequently passing these diverging beams through a prism, such as a roof prism, made for example, from glass, the sub-beams are made parallel.

Thus, instead of requiring a large crystal to perform both the splitting function and the function of providing parallel beams, in this invention, one or more very small crystals provide two diverging beams and the inexpensive glass prism performs the steering function of ensuring that the beams become parallel.

### BRIEF DESCRIPTION OF THE DRAWINGS

Exemplary embodiments of the invention will now be described in conjunction with some the accompanying figures, in which:

FIG. 1 is an illustration of a prior art filter which utilizes a beam splitting cube and a reflector to achieve beam separation of an input beam into two orthogonally polarized parallel sub-beams;

FIG. 2 is an illustration of a prior art optical circulator which utilizes birefringent a crystals to achieve beam separation of an input beam into two orthogonally polarized parallel sub-beams;

FIG. 3 is an illustration of a prior art controllable switchable filter which utilizes birefringent a crystals to achieve beam separation of an input beam into two orthogonally polarized parallel sub-beams;

FIG. 4 is is a birefringent crystal, of the type shown in FIGS. 2 and 3;

FIG. 5 is a top view of a beam/splitter combiner in accordance with an embodiment of the invention utilizing Wallaston prisms and a glass roof prism;

FIG. 6 is a top view of a beam/splitter combiner in accordance with another embodiment of the invention wherein a birefringent wedge is directly coupled with a non-birefringent wedge and where only one of the sub-beams passes through a glass wedge to bend a beam passing therethough;

FIG. 7 is a top view of an alternative embodiment wherein four birefringent wedges are utilized;

FIG. 8 is a top view of an embodiment similar to FIG. 5, wherein two input beams are split into two parallel orthogonally polarized pairs of output sub-beams; and,

FIG. 9 is a top view of an assembly in accordance with the invention.

### DETAILED DESCRIPTION

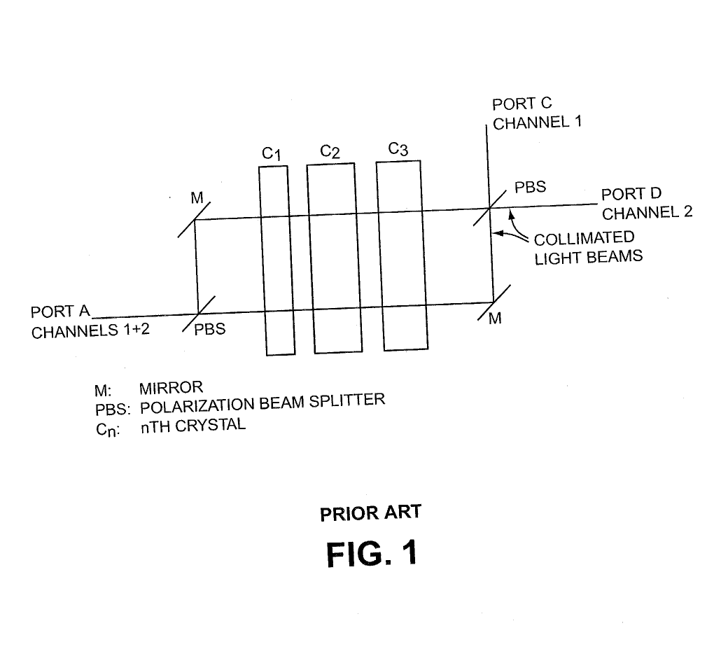

The requirement to separated a beam into two orthogonally polarized sub-beams which are parallel to one another is illustrated in many optical circuits. Referring now to FIG. 1 a filtering device described in detail in U.S. Pat. No. 4,685,773 incorporated herein by reference, is shown wherein a beam splitter labeled PBS is optically coupled with a mirror for splitting in input beam into two orthogonally parallel output sub-beams. In this device the sub-beams propagate through birefringent waveplates and are later partially combined and mixed through a similar arrangement of components. In some instances beam splitters of this type do not provide an adequate extinction ratio.

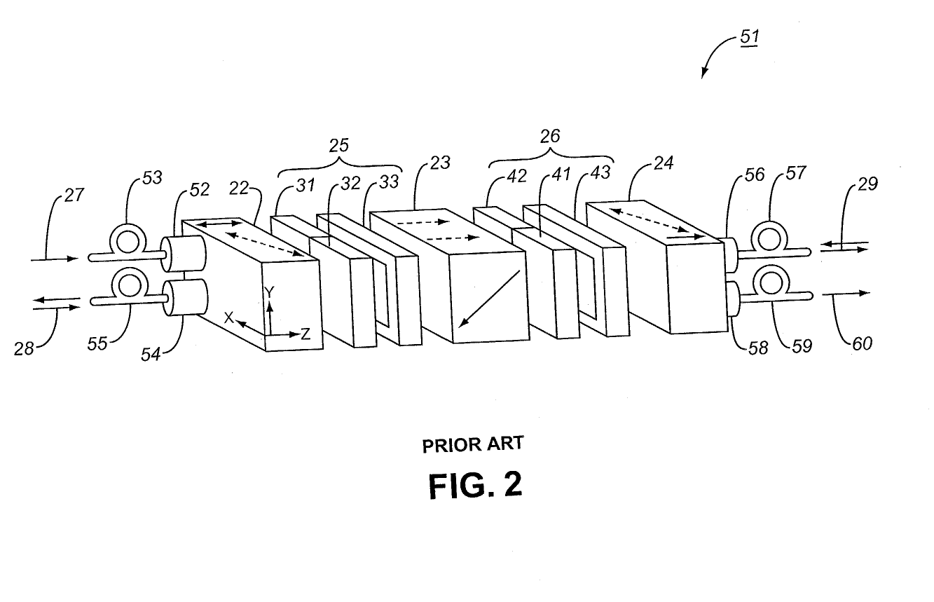

FIG. 2 is a prior art optical circulator wherein a birefringent crystal 22 is used to separate an input beam 27 into two orthogonally parallel sub-beams which emerge from the crystal to propagate through other components 22, 31, 32, 33, etc. as parallel sub-beams. The circuit of FIG. 2 is shown and described in detail in U.S. Pat. No. 5,204,771 as FIG. 7, incorporated herein by reference.

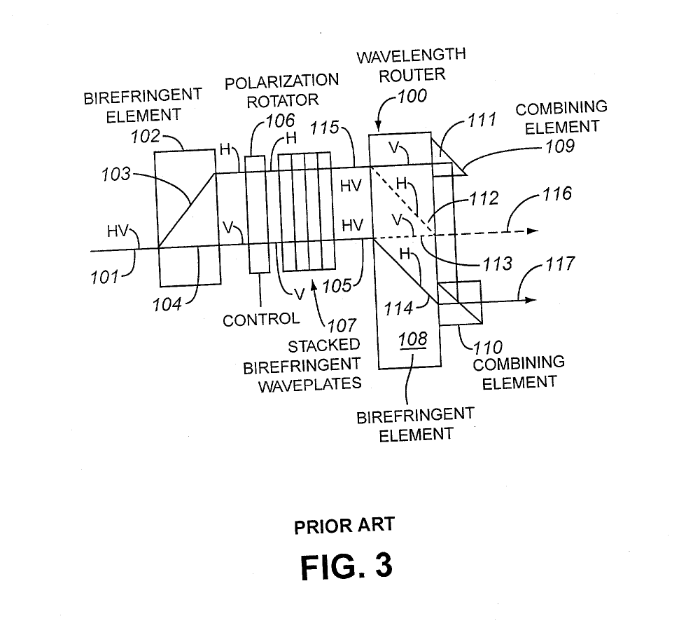

FIG. 3 is a prior art optical filter described in detail in U.S. Pat. No. 5,867,291 incorporated herein by reference, wherein a birefringent element 102 is used to separate an input beam 101 into two diverging sub-beams within the element 102 and wherein the beam exit as two parallel orthogonally polarized sub-beams labeled H and V. Generally, when two split orthogonally sub-beams are to be subsequently launched into same other components, it is required for the two sub-beams to be parallel.

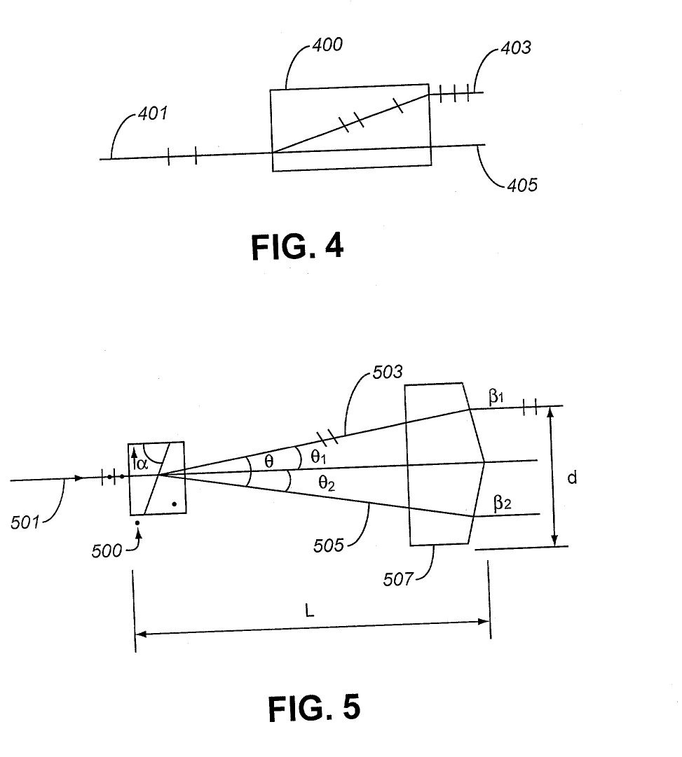

FIG. 4 shows a birefringent crystal 400 such as a rutile crystal or lithium niobate crystal, wherein a beam 401 is launched into an input end and is split into two orthogonally polarized sub-beams 403 and 405. As the beams exit the output end, they are parallel and remain separated. If the crystal was lengthened and its height increased, the distance between the separated parallel beam would increase. Thus, the beam separation distance is a function of the size of the crystal.

FIG. 5 illustrates an embodiment of the instant invention wherein a Wallaston prism or polarizer 500 is used; the Wallaston prism is formed from two birefringent elements that have their axes orthogonal to one another as indicated. An input beam 501 is launched into an end of the Wallaston prism 500 and is separated into two diverging sub-beams 503 and 505; the angles θ₁ and θ₂ at which the beams diverge from the input beam launch line is a function of the cut of the crystal wedges and a function of the material of the prism itself. The angles θ₁ and θ₂ are substantially equal. After the orthogonally polarized beams 503 and 505 diverge and pass through free space, they are launched into and through a roof prism 507, and exit the prism as separated into orthogonally polarized parallel sub-beams β₁ and β₂. Increasing the distance between the two parallel beams can be achieved in two ways; by using wedge prisms that will increase the angle angles θ₁ and θ₂, and/or by increasing the distance L which can simply be achieved by increasing the free space distance between the prisms 500 and the roof prism 507.

Construction of the beam combiner/splitter shown in FIG. 5 is depicted in the top view shown in FIG. 9.

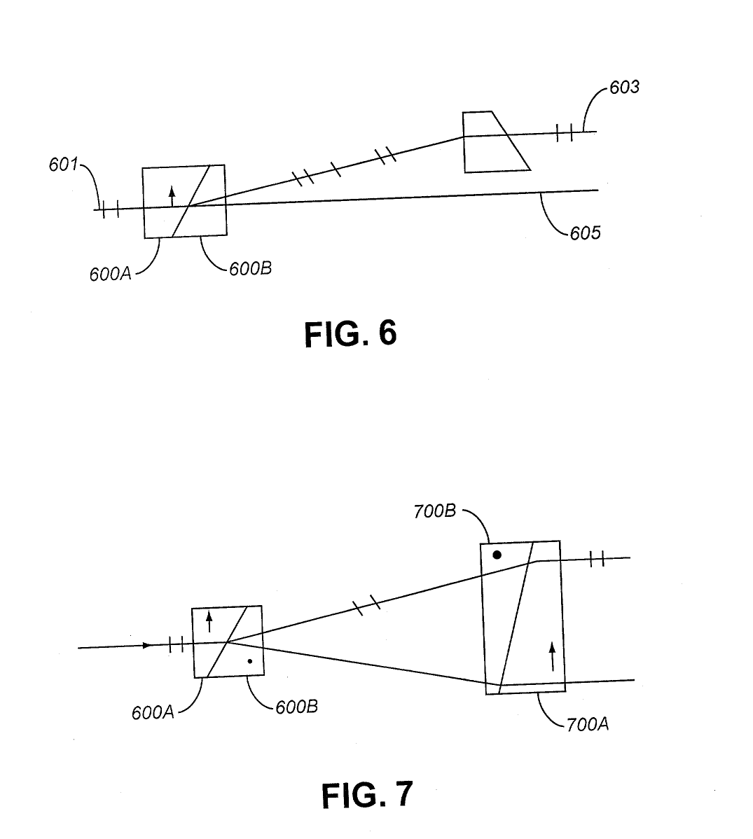

FIG. 6 depicts an embodiment of the invention wherein two small wedges are used to provide walk-off of one beam. The combination of wedges is also known as a Rochon prism. Although one beam remains propagating along a straight through path, the two beams are said to be diverging beams. Wedge 600a is a birefringent wedge and wedge 600b is a glass wedge. An incident beam 601 is separated into two sub-beams by wedge 600a which are orthogonally polarized and the glass wedge 600b directs one of the two sub-beams 605 along the straight path it was on; the sub-beam 603 is directed away at an angle from the line of the incident beam. A single wedge glass prism is disposed in the path of the beam 603 to bend the beam such that it is parallel to 605. Less separation is afforded in this embodiment than in FIG. 5 since only one beam diverges from the principle axis along which the input beam is launched.

Turning now to FIG. 7, an alternative embodiment of the invention is shown wherein Wallaston polarizer comprising prisms 600a and 600b is utilized in a similar manner as in FIG. 6, and another larger but reversed Wallaston polarizer is used such that prism 600a corresponds to prism 700a and prism 600b corresponds to prism 700b in orientation. By launching a single beam into an end of prism 600a, two parallel orthogonally polarized sub-beams emerge from ports on prism 700a.

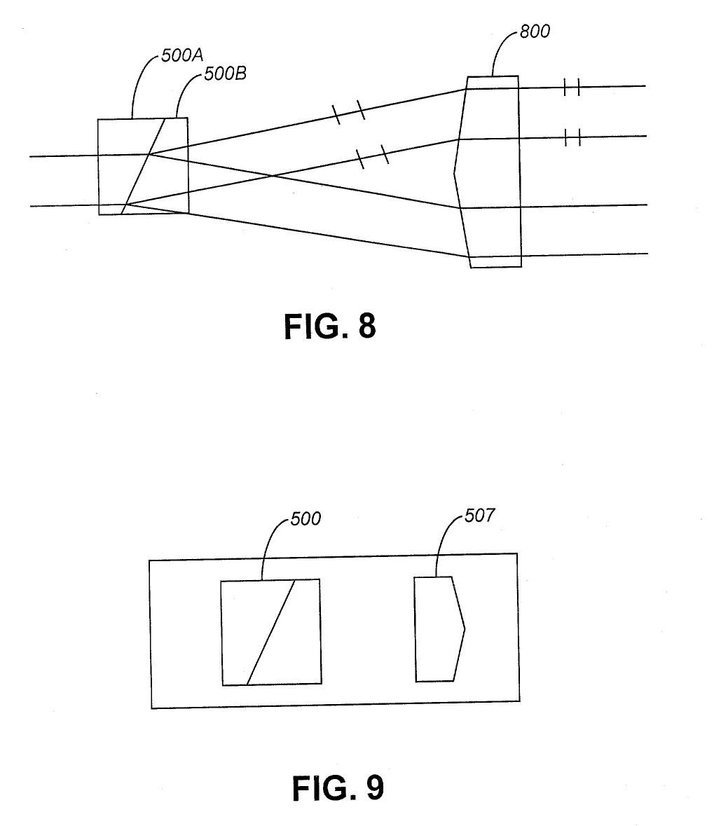

FIG. 8 is an embodiment of the invention wherein two separate beams are launched into Wallaston prisms 500a and 500b and which propagate through a glass roof prism 800 oriented oppositely from roof prism 507 in FIG. 5 to produce two pairs of parallel orthogonally polarized beams.

In all of the embodiments shown and described heretofore, the use of only two primary spaced apart modules, a beam splitting module for providing orthogonally polarized diverging beams comprised of two blocks and a beam steering block for making diverging beams parallel, provides an inexpensive optical device with a high extinction ratio for splitting and or combining beams in a polarization dependent manner. Increasing the separation of the two parallel beams can be achieved by increasing the distance between the two modules forming the optical device or by ensuring that the beams diverge at a larger angle.

What is claimed is:

1. A polarization beam splitter comprising:
a first beam splitting means comprising at least one birefringent element having a port for receiving an input beam and having two output ports, said first means for separating the input beam into two orthogonally polarized non-parallel output sub-beams; and,
converting means optically coupled to the two output ports of the first beam splitting means for receiving the non-parallel orthogonally polarized output sub-beams and for converting said non-parallel output sub-beams to parallel orthogonally polarized output beams.

2. A polarization beam splitter as defined in claim 1, wherein the converting means is a light bending means.

3. A polarization beam splitter as defined in claim 2, wherein the light bending means is a light transmissive roof prism.

4. A polarization beam splitter as defined in claim 3, wherein a roof of the roof prism is directly facing the first beam splitting means.

5. A polarization beam splitter as defined in claim 3, wherein a flat side directly opposite the roof of the roof prism is directly facing the first beam splitting means.

6. A polarization beam splitter as defined in claim 2, wherein the first beam splitting means comprises a Wallaston prism.

7. A polarization beam splitter as defined in claim 6, wherein the light bending means comprises a Wallaston prism.

8. A polarization beam splitter as defined in claim 2, wherein the light bending means is a light transmissive glass prism.

9. A device for splitting a single beam into two orthogonally polarized parallel sub-beams, or for combining two parallel orthogonally polarized sub-beams into a single beam, comprising:
first and second light transmissive wedge-shaped blocks of light transmissive material, at least one of said wedge-shaped blocks being birefringent; one of said blocks having a single port for receiving or transmitting the single beam, the other of the two blocks having two ports for receiving converging orthogonally polarized sub-beams of light or for providing diverging orthogonally polarized sub-beams of light;
one or more light transmissive blocks, spaced from the first and second light transmissive wedge-shaped blocks of light transmissive material configured to convert non-parallel orthogonally polarized sub-beams received from the two ports such that they become parallel in a first mode of operation or to provide two converging orthogonally polarized sub-beams of light to the two ports when two orthogonally polarized parallel sub-beams of light are launched therein.

10. A device as defined in claim 9, wherein the one or more light transmissive blocks comprises a non-birefringent roof prism.

11. A device as defined in claim 9, wherein said one of said blocks having a single port is a birefringent block.

12. A polarization beam splitter comprising:
first means for receiving an input beam and for splitting said input beam into two diverging orthogonally polarized sub-beams of light; and,
second means spaced from said first means for receiving at least one of the diverging orthogonally polarized sub-beams of light and for bending said at least one or more diverging sub-beams of light such that the two diverging sub-beams become parallel.

13. A polarization beam splitter as defined in claim 12, wherein the first means and the second means are absent other optical elements disposed within a light transmitting path therebetween.

14. A polarization beam splitter as defined in claim 12 wherein the first means comprise a a birefringent block of material for splitting into two diverging orthogonally polarized sub-beams optically coupled with a non-birefringent block for bending and steering one or more of the two sub-beams such that they are directed to input locations at the second means;

15. A polarization beam splitter as defined in claim 12 wherein the first means comprise a two birefringent blocks having their principle axes oriented orthogonally to one another.

16. A polarization beam splitter as defined in claim 12 wherein the second means spaced from said first means is a block of non-birefringent material disposed to receive and bend only one of the sub-beams of light.
